(19) United States
(12) Patent Application Publication
(10) Pub. No.: US 2008/0033099 A1
(43) Pub. Date: Feb. 7, 2008

(54) Paint Composition for Adherence To Plastic

(75) Inventor: Michael W. Bosway, Chagrin Falls, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 11/461,817

(22) Filed: Aug. 2, 2006

(51) Int. Cl. C09B 67/00

(52) U.S. Cl. 524/502

(57) ABSTRACT

A paint product that includes a solvent-borne paint composition that includes volatile organic solvents, an acrylic modified alkyd resin, a long oil alkyd, a chlorinated polyolefin modified acrylic resin, and a colorant.

This invention relates to paint compositions in general and, more particularly, to solvent-borne paint compositions that have good adherence to plastic substrates.

The features, aspects, and advantages of the present invention will become better understood with regard to the following description, appended claims, and accompanying drawing where:

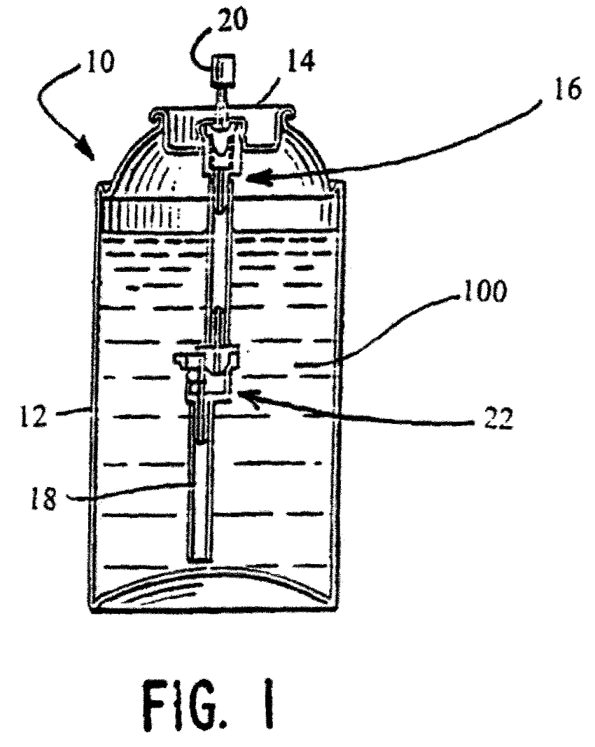

FIG. 1 shows a schematic view of an aerosol container charged with an aerosol paint composition embodied in accordance with the present invention.

As used herein, the term “volatile organic solvent” shall mean an organic solvent capable of vaporizing at atmospheric pressure and a temperature in a range from about 35° F. to about 140° F.

The paint composition of the present invention generally comprises a solvent-borne paint composition. The paint composition is substantially free of water. In one embodiment, the paint composition may be an aerosol paint composition comprising the solvent-borne paint composition and an aerosol propellant.

The solvent-borne paint composition generally comprises a solvent system, a resin system and colorant.

The solvent system comprises at least one volatile organic solvent, more preferably a mixture of at least two volatile organic solvents. Volatile organic solvents that may be used in the solvent system include alcohols, such as methanol, ethanol, isopropanol, 2-butoxy ethanol, and n-butyl alcohol; ketones, such as acetone, methyl ethyl ketone, methyl propyl ketone, methyl amyl ketone, and methyl isobutyl ketone; propylene and ethylene glycol ethers and acetates; aliphatic and aromatic hydrocarbons and naphthas, such as aromatic 100; petroleum and wood distillates; turpentine; pine oil, and the like. Mixtures of the foregoing solvents may also be used. In one embodiment, the solvent system comprises acetone, toluene, xylene and at least one alcohol and at least one ketone. In another embodiment, the solvent system comprises aromatic naphtha and methyl amyl ketone.

The amount of the solvent system present in the solvent-borne paint composition is at least 20 weight percent of the total weight of the solvent-borne paint composition. For example, the amount of the solvent system present in the solvent-borne paint composition may be from about 20 to about 50 weight percent, further for example, from about 20 to about 30 weight percent, and even further for example about 25 to about 35 weight percent of the total weight of the solvent-borne paint composition.

The resin system comprises an acrylic modified alkyd resin, a long oil alkyd, and a chlorinated polyolefin modified acrylic resin. This combination of resins can provide coatings which are convenient to apply by brushing, rolling, spraying, or as aerosol products and which provide excellent adhesion to plastics, as well as good initial gloss and gloss retention and durability. These properties cannot be achieved with any of the resins alone.

The acrylic modified alkyd resin is comprised of an acrylic portion and an alkyd portion.

The acrylic portion is formed from monomers comprising at least one acrylic monomer and can be a homopolymer or a copolymer. Preferably, the acrylic portion is a copolymer formed from at least one acrylic monomer and a vinyl aromatic hydrocarbon, such as styrene, a methyl styrene or other lower alkyl styrene, chlorostyrene, vinyl toluene, vinyl naphthalene, or divinyl benzene. More preferably, the acrylic portion is formed from at least one acrylic monomer and vinyl toluene. Suitable acrylic monomers include any compounds having acrylic functionality, such as alkyl (meth)acrylates, acrylic acids, as well as aromatic derivatives of (meth)acrylic acid, acrylamides and acrylonitrile. Typically, the alkyl (meth)acrylate monomers (commonly referred to as “alkyl esters of (meth)acrylic acid”) will have an alkyl ester portion containing from 1 to 12, preferably about 1 to 5, carbon atoms per molecule. Suitable acrylic monomers include, for example, methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate, 1-adamatyl methacrylate and various reaction products such as butyl, phenyl, and cresyl glycidyl ethers reacted with (meth)acrylic acid, hydroxyl alkyl (meth)acrylates, such as hydroxyethyl and hydroxypropyl (meth)acrylates, amino (meth)acrylates, as well as acrylic acids such as (meth)acrylic acid, ethacrylic acid, alpha-chloroacrylic acid, alpha-cycanoacrylic acid, crotonic acid, beta-acryloxy propionic acid, and beta-styryl acrylic acid. One of the preferred acrylic monomers is butyl acrylate.

The alkyd portion of the acrylic modified alkyd resin and the long oil alkyd may be formed by one of the traditional processes, such as: (i.) the direct esterification of a drying oil fatty acid with a dicarboxylic acid and a polyhydric alcohol, (ii.) the indirect esterification of a drying oil by first alcoholization with a polyhydric alcohol and second esterification with a polybasic acid, or a (iii.) two-step process wherein the first step comprises the acidolysis reaction of a triglyceride oil with a trifunctional carboxylic acid or a trifunctional anhydride, and the second step comprises reacting the product of the first step with a multifunctional alcohol, as is disclosed in U.S. Pat. No. 4,983,716, which is hereby incorporated by reference.

Typical raw materials for the formation of alkyds include triglyceride oils or the fatty acids thereof. These can be selected from the group consisting of linseed oil, soya oil, coconut oil, cottonseed oil, peanut oil, canola oil, corn oil, safflower oil, sunflower oil, dehydrated castor oil, fish oil, perilla, lard, walnut oil, tang oil, tall oil, the fatty acids thereof and mixtures thereof. Particularly preferred are those oils and acids containing unsaturation in the glyceride chains. Particularly preferred are soya oil, dehydrated castor oil and linseed oil and the fatty acids thereof.

Multi-functional alcohols, and mixtures thereof, are also common raw materials for the production of alkyds. One suitable hexafunctional alcohol includes dipentaerythritol. One suitable tetrafunctional alcohol includes pentaerythritol. Suitable trifunctional alcohols include the group consisting of trimethylol propane, trimethylol ethane, glycerine, tris hydroxyethyl isocyanurate, and mixtures thereof, either alone or in combination with a difunctional alcohol selected from the group consisting of ethylene glycol, propylene glycol, cyclohexane dimethanol, and mixtures thereof. Additionally, dimethylol propionic acid can be used in combination with the trifunctional alcohol.

Another typical raw material used in the formation of alkyds is multifunctional carboxylic acids or anhydrides. Suitable trifunctional carboxylic acids include trimelletic acid, trimesic acid, 1,3,5-pentane tricarboxylic acid, citric acid and others whereas suitable trifunctional anhydrides include trimelletic anhydride, pyromelletic anhydride and others. Difunctional carboxylic acids include phthalic acid, isophthalic acid, terephthalic acid, maleic acid and fumaric acid and mixtures thereof. Mixtures of such acids and anhydrides are also acceptable.

The acrylic modified alkyd resin may be formed by contacting and reacting, under free radical polymerization conditions, the acrylic portion monomers with either the pre-formed alkyd resin or, alternatively, with the alkyd resin precursors during the formation of the alkyd resin. The acrylic modified alkyd resin may also be formed by other methods, such as first forming the acrylic portion so as to have pendant carboxy substituents (and optionally hydroxy substituents) and then reacting this polymer with a mixture of alkyd resin components or precursors, i.e., a polycarboxylic acid (or, alternatively, the corresponding anhydride), a polyhydric alcohol, and a fatty acid (or, alternatively, the corresponding triglyceride or fatty acid oil), as is disclosed in U.S. Pat. No. 4,010,126, which is hereby incorporated by reference.

Example of commercially available acrylic modified alkyd resins that may be used in the aerosol paint composition is POLYCHEM 7060-V-60, 7006-X-50, 7584-V-60 and 7447-x-80 all sold by OPC Polymers of Columbus, Ohio. The listed resins are acrylic modified alkyd resins formed from soya oil.

Long oil alkyds are generally those having an oil content greater than about 60%, for example about 70% to about 80% oils. Long oil alkyds may also be defined as containing about 20% to about 30% phthalic anhydride, the balance being oils. The oil acids in an alkyd contribute flexibility, air drying properties, adhesion and solubility in solvents. One example of a commercially available long oil alkyd is BECKOSOL® 1272 sold by Reichhold. BECKOSOL® 1272 long oil alkyd had also been marketed as AROPLAZ® 1272 and is a 100% solids, long oil soya alkyd.

The chlorinated polyolefin modified acrylic resin is comprised of an acrylic portion and a chlorinated polyolefin portion.

The acrylic portion is formed from monomers comprising at least one acrylic monomer and can be a homopolymer or a copolymer. Suitable acrylic monomers are listed above in connection with the acrylic modified alkyd resin.

The chlorinated polyolefin portion can be chlorinated polypropylene, chlorinated polybutene, chlorinated polyethylene, and mixtures thereof.

The chlorinated polyolefin modified acrylic may be formed by graft polymerizing the monomers of the acrylic portion onto the chlorinated polyolefin portion using one or more polymerization initiators, such as benzoyl peroxide, di-tert-butyl peroxide and/or azobisisobutyronitrile. Known polymerization techniques can be used for the graft polymerization. A method of forming such an acrylic modified chlorinated polyolefin is disclosed in U.S. Pat. No. 5,603,939, which is hereby incorporated by reference.

A commercially available chlorinated polyolefin modified acrylic that may be used in the aerosol paint composition is DORESCO® AC439-1, which is available from Noveon. AC439-1 has also been marketed as DORESCO AC423-17 and is a thermoplastic acrylic resin solution at aoproximately 62% NVM in toluene and xylene. Another commercially available useful chlorinated polyolefin modified acrylic is DORESCO® AC439-29 which is also a thermoplastic acrylic resin solution at approximately 65% solids in aromatic 100.

The weight solids ratio of chlorinated polyolefin modified acrylic to acrylic modified alkyd resin can vary from about 9 to 1 to about 1 to 9, but for many applications the ratio (on a weight solids basis) of chlorinated polyolefin modified acrylic to acrylic modified alkyd resin in the solvent-borne paint composition may be from about 1.2 to 1 to about 1 to 2.2. In one useful embodiment, the ratio of the chlorinated polyolefin modified acrylic plus the acrylic modified alkyd to the long oil alkyd is between about 1.8 to 1 to about 1 to 1. In another useful embodiment, the ratio of the acrylic modified alkyd plus the long oil alkyd to the chlorinated polyolefin modified acryl is between about 4 to 1 to about 2 to 1.

In one useful embodiment, the solvent borne paint composition of the present invention may comprise about 15% to about 45%, for example about 40% to about 45%, further for example about 15% to about 20% acrylic modified alkyd, about 35% to about 50%, for example about 35% to about 40%, further for example about 45% to about 50% long oil alkyd, and about 20% to about 35%, for example about 20% to about 25%, further for example about 30% to about 35% chlorinated polyolefin modified acrylic. The amounts specified are all on a solids basis.

The amount of the resin system present in the solvent-borne paint composition is typically at least 30 weight percent of the total weight of the solvent-borne paint composition. In one embodiment, the amount of the resin system present in the solvent-borne paint composition is from about 30 to about 80 weight percent, for example from about 40 to about 65 weight percent, further for example about 40 to about 55 weight percent of the total weight of the solvent-borne paint composition.

The solvent-borne paint composition may also incorporate colorants. The colorant can comprise for example one or more of the following: titanium dioxide, carbon black, graphite, ceramic black, lamp black, antimony sulfide, black iron oxide, aluminum pastes, yellow iron oxide, red iron oxide, iron blue, phthalo blue and green, nickel titanate, dianisidine orange, dinitroaniline orange, imidazole orange, quinacridone red, violet and magenta, toluidine red, molybdate orange, and the like.

The solvent-borne paint composition of the present invention may include other ingredients, such as surfactants and dispersants, rheology modifiers, extenders, anti-skinning agents, drying agents, light stabilizers and ultraviolet light absorbers.

Suitable dispersants and surfactants can comprise any of the dispersants and surfactants readily available to the coatings industry, including the anionic and nonionic surfactants, soya lecithin, alkyl ammonium salts of fatty acids, amine salts of alkyl aryl sulfonates, unsaturated organic acids, sulfonated castor oil, mixtures of high boiling point aromatic and ester solvents, sodium salts of aryl sulfonic acid, and the like.

Suitable rheology modifiers can comprise organoclays, fumed silica, dehydrated castor oil organic derivatives, English China Clay; polyamides, polyamide modified alkyds, alkylbenzene sulphonate derivatives, aluminum, calcium and zinc stearates, calcium soyate, and the like.

Suitable extenders can comprise amorphous, diatomaceous, fumed, quartz and crystalline silica, clays, aluminum silicates, magnesium aluminum silicates. talc, mica, delaminated clays, calcium carbonates and silicates, gypsum, barium sulfate, zinc, calcium zinc molybdates, zinc oxide, phosphosilicates and borosilicates of calcium, barium and strontium, barium metaborate monohydrate, and the like.

Anti-skinning agents that may used include methyl ethyl ketoxime, o-cresol, and hydroquinone.

Drying agents, which facilitate the cure of the alkyd materials, can comprise standard metallic and rare earth driers such as cobalt, calcium, potassium, barium, zinc, manganese, tin, aluminum, zirconium and vanadium napthenates, octoates, hexanates, and isodecanoates.

An aerosol paint composition of the present invention may be formed by combining the solvent-borne paint composition (described above) with additional solvents and then aerosolizing the combination with the propellant.

In an aerosol paint composition, the propellant is a liquafiable gas having a vapor pressure sufficient to propel the aerosol paint composition from the container. Preferably, the propellant is selected from the group consisting of ethers, such as dimethyl ether (DME) and diethyl ether; C1-C4 saturated hydrocarbons, such as methane, ethane, propane, n-butane, and isobutane; hydrofluorocarbons (HFC), such as 1,1,1,2-tetrafluoroethane (HFC-134a), 1,1,1,2,3,3,3,-heptafluoropropane (HFC-227HFC), difluoromethane (HFC-32), 1,1,1-trifluoroethane (HFC-143a), 1,1,2,2-tetrafluoroethane (HFC-134), and 1,1-difluoroethane (HFC-152a); and mixtures of the foregoing. More preferably, the propellant is a blend of n-butane and propane.

If included, the amount of the propellant present in an aerosol paint composition is typically at least 10 weight percent and preferably from about 10 to about 40 weight percent, more preferably from about 15 to about 25 weight percent of the total weight of the aerosol paint composition. When the propellant is present in an amount of from about 15 to about 25 weight percent, an initial pressure of between about 40 pounds per square inch and 70 pounds per square inch is obtained in the container.

In one embodiment of the present invention, the solvent-borne paint composition is an aerosol paint composition. In such an embodiment, the amount of volatile organic solvent present in the aerosol paint composition is at least about 30 weight percent of the total weight of the aerosol paint composition. For example, the amount of volatile organic solvent present in the aerosol paint composition may be from about 30 to about 60 weight percent, further for example from about 45 to about 55 weight percent of the total weight of the aerosol paint composition.

In another embodiment of the invention, the solvent borne paint composition is a bulk (non-aerosol) paint formulation. In such an embodiment, the paint may be formulated to have a VOC of under 380 grams per liter.

In one embodiment, the solvent-borne paint composition of the present invention is made in a batch process at or below a temperature of 70° F. The solvent system is charged one solvent at a time to a mixing vessel and blended for a short period of time to achieve a state of equilibrium. Pigment colorants are dispersed in the acrylic modified alkyd resin. Then the pigment colorant/acrylic modified alkyd resin dispersion are mixed with the chlorinated polyolefin modified acrylic and the long oil alkyd and are charged to the mixing vessel and mixed with high shear dispensers to achieve complete dissolution in the solvent system. Other ingredients are then added in stepwise fashion and thoroughly mixed therein. The resulting solvent-borne paint composition is filtered through a 10 micron filter bag to remove any large agglomerations. The solvent-borne paint composition is then added to a container, such as container 10 shown in FIG. 1, and then the propellant is added to form the aerosol paint composition.

Referring now to FIG. 1, a container 10 for an aerosol paint composition comprises a can 12, to which a valve cup 14 is secured. A valve assembly 16 with a dip tube 18 connected thereto is secured to the valve cup 14. The dip tube 18 extends into the interior of the can 12 and is in contact with the aerosol paint composition, which is designated by the numeral 100. The can 12 may be composed of aluminum or more preferably tin plated steel. The valve cup 14 may be sealed to the can 12 and the propellant charged through the valve assembly 16, or the can 12 may be charged with the propellant under the valve cup 14, and then the valve cup 14 sealed to the can 12. An actuator 20 is then connected to the valve assembly 16.

Various valves, dip tubes and actuators may be used to spray the aerosol paint composition. Preferably, the dip tube 18 is a standard dip tube having a diameter of about 0.147 inches. The valve assembly 16 may be either a “female” aerosol valve or a “male” aerosol valve. Examples of “female” aerosol valves that may be used in the present invention are disclosed in U.S. Pat. Nos. 3,033,473; 3,061,203; 3,074,601; 3,209,960; and 5,027,985. Examples of “male” aerosol valves that may be used in the present invention are disclosed in U.S. Pat. Nos. 2,631,814, and 4,572,406. Preferably, the valve assembly 16 is a “female” valve with a spray controller 22 having a construction as disclosed in U.S. Pat. No. 4,572,406, which is hereby incorporated by reference. The spray controller 22 permits the aerosol paint composition 100 to be dispensed when the container 10 is inverted.

The aerosol paint composition of the present invention adheres to a variety of different surfaces, including metal, wood and especially plastic.

The invention will be better understood by reference to the following examples:

### EXAMPLE 1

A white batch of the inventive solvent-borne paint composition was formed in a mixing vessel. The batch was formed from the following components in the noted amounts, where parts are parts by weight.

| | |
|---|---|
| Aromatic naphtha (100 flash) | 178.285 |
| MACOPOL 214-2758¹ | 226.165 |
| Soya lecithin | 7.4389 |
| 8% calcium drier | 9.6377 |
| BYK 066 defoamer² | 5.0204 |
| Titanium dioxide | 227.9072 |
| ACEMATT ® OK412³ | 61.6814 |
| DORESCO ® AC439-29⁴ | 124.3576 |
| AROPLAZ ® 1272⁵ | 138.7831 |
| BYK-077⁶ | 3.0122 |
| 12% cobalt drier | 1.0279 |
| 18% 2-Ethylhexanoate | 2.57 |
| Methyl ethyl ketoxime | 1.2336 |
| BYK 411⁷ | 15.5761 |
| Lampblack | 0.1324 |
| Total Parts by Weight | 1002.8285 |

¹Acrylic/vinyl toluene modified alkyd available from Resolution Specialty Materials.
²Solution of foam destroying polysiloxane in diisobutyl ketone available from BYK-Chemie.
³Silica gel/precipitated silica available from Degussa.
⁴Chlorinated polyolefin modified acrylic available from Noveon.
⁵Long oil soya alkyd, also sold commercially as BECKOSOL ® 1272.
⁶Organic modified polysiloxane available from BYK Chemie.
⁷Rheological additive comprising a solution of a modified urea in 1-methyl-2-pyrrolidone.

The paint composition can be applied to a suitable substrate, such as plastic, and allowed to dry or cure.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. A coating composition comprising:
(a.) an acrylic modified alkyd resin;
(b.) a long oil alkyd;
(c.) an chlorinated polyolefin modified acrylic;
(d.) a volatile organic solvent;
(e.) a drying agent; and
(f.) a colorant.

2. The coating of claim 1 wherein the chlorinated polyolefin modified acrylic plus the acrylic modified alkyd and the long oil alkyd are present at a weight solids ratio between about 1 to 1.8 and about 1 to 1.

3. The coating of claim 1 wherein the acrylic modified alkyd plus the long oil alkyd and the chlorinated polyolefin modified acrylic are present at a weight solids ratio between about 4 to 1 and about 2 to 1.

4. The coating composition of claim 1 wherein the composition is substantially free of water.

5. A coating composition comprising:
(a) about 30 to about 80 weight percent of a resin system comprising an acrylic modified alkyd resin, a long oil alkyd, and an chlorinated polyolefin modified acrylic resin;
(b) a volatile organic solvent;
(e) a drying agent; and
(d) a colorant.

6. The coating composition of claim 5 wherein about 35% to about 40% of the total solids weight of the resin system is a long oil alkyd.

7. The coating composition of claim 5 wherein about 45% to about 50% of the total solids weight of the resin system is a long oil alkyd.

8. The coating composition of claim 5 wherein about 20% to about 25% of the total solids weight of the resin system is chlorinated polyolefin modified acrylic.

9. The coating composition of claim 5 wherein about 30% to about 35% of the total solids weight of the resin system is chlorinated polyolefin modified acrylic.

10. The coating composition of claim 5 wherein about 40% to about 45% of the total solids weight of the resin system is acrylic modified alkyd.

11. The coating composition of claim 5 wherein about 15% to about 20% of the total resin solids weight of the resin system is acrylic modified alkyd.

12. The coating composition of claim 5 wherein the paint product is substantially free of water.

13. A process of coating a substrate comprising:
(i) providing a paint composition comprising about 30 to about 80 weight percent of a resin system comprising an acrylic modified alkyd resin, a long oil alkyd, and an chlorinated polyolefin modified acrylic resin, a volatile organic solvent, a drying agent, and a colorant;
(ii) applying the paint composition to a surface;
(iii) allowing the paint composition to cure or dry.
